(19) United States
(12) Patent Application Publication
(10) Pub. No.: US 2021/0055715 A1
(43) Pub. Date: Feb. 25, 2021

(54) PROPOSAL EVALUATION MECHANISM OF EQUIPMENT/SYSTEM DEGRADATION AND DESIGN CONDITION DEVIATION FOR PRODUCTION PLANT OR FACILITY

(71) Applicant: Jia Kai Energy Technology Co., Ltd., New Taipei City (TW)

(72) Inventor: Wein-Joe Yang, New Taipei City (TW)

(21) Appl. No.: 16/997,943

(22) Filed: Aug. 20, 2020

(30) Foreign Application Priority Data
Aug. 23, 2019 (TW) 108130257

(51) Int. Cl. G05B 19/418; G05B 23/02

(52) U.S. Cl. CPC G05B 19/41885; G05B 19/4183; G05B 23/0254

(57) ABSTRACT

A proposal evaluation mechanism of equipment/system procurement for production plant or facility includes: a supplier unit, a first setting unit, a first calculation unit, a second setting unit, and a second calculation unit. The supplier unit includes a plurality of suppliers and is provided for individually submitting a first curve function and a second curve function to the first setting unit and the second setting unit to be subjected to calculation. This calculation will be conducted based the first calculation unit and the second calculation unit according to settings contained in the first setting unit and the second setting unit to determine a first efficiency calculation function, and a first production capacity calculation function, a second efficiency calculation function, and a second production capacity calculation function accordingly. Comparison is made among different ones of the suppliers with respect to such functions to serve as basis of determination for tendering award.

### TECHNICAL FIELD OF THE INVENTION

The present invention relates to a proposal evaluation mechanism, and more particularly to a proposal evaluation mechanism of equipment/system procurement for production plant or facility that analyzes multiple proposal-offering parties in respect of statuses of efficiency and production capacity.

### DESCRIPTION OF THE PRIOR ART

For all sorts of constructions of new production plants or facilities (power plants, steam power plants, chemical plants, electronic works, electronic workshops, and other production units of which production capacity and resources efficiency are primary concerns) or renovation projects of existing facilities, in addition to the consideration of total completion cost, the factors on which the known tendering processes base in respect of supplier selection and decision making also include production capacity and utilization efficiency of resources, which are considered important concerns of supplier selection for evaluation of all sorts construction projects and construction contractors facility (system). Particularly, at the initial phase of a plant construction project, the evaluation mechanism included in a tender invitation document or assessment performed in a tender reviewing process are important factors on which decision is made regarding determination of undertaking suppliers. However, the evaluation of plant projects are usually conducted based on fixed design conditions, which generally include the following conditions as evaluation basis for award of contract:

(1) operation hours set for acceptance (such as accumulated 250 hours of production after commercial operation or start-up);

(2) input of man power;

(3) ambient pressure (e.g. 1013 mbar);

(4) relative humidity (e.g. RH 90%);

(5) fuel composition or ingredients of raw material; and

(6) other design factors that affect production capacity and efficiency.

However, the actual operation conditions at the acceptance test are often deviated from the design conditions, and the acceptance test result must be corrected in accordance with the correction curves submitted by the undertaker contractor. Such correction curves may vary greatly from contactor to contractor. Prior to award of contract, the differences of correction curves among all bidders are usually not evaluated. This often leads to the condition that good equipment (system) suppliers fail the tender, while the supplier with worse overall performance, after applying correction curves in terms of production capacity or efficiency, is awarded the contract.

Therefore, neglecting the correction curves differences among bidders could eventually cause benefit loss to the public production facility or the private business due to poor overall performance of contractor's equipment (system).

### SUMMARY OF THE INVENTION

The present invention provides a proposal evaluation mechanism of equipment/system procurement for production plant or facility, which includes: a supplier unit, a first setting unit, a first calculation unit, a second setting unit, and a second calculation unit. The supplier unit includes a plurality of suppliers and is provided for individually submitting a first curve function and a second curve function to the first setting unit and the second setting unit to be subjected to calculation. This calculation will be conducted based the first calculation unit and the second calculation unit according to settings contained in the first setting unit and the second setting unit to determine a first efficiency calculation function, a first production capacity calculation function, a second efficiency calculation function, and a second production capacity calculation function accordingly. Comparison is made among different ones of the suppliers with respect to the first efficiency calculation function, the first production capacity calculation function, the second efficiency calculation function, and the second production capacity calculation function to serve as basis of determination for tendering award.

The present invention is made, for constructions of new production plants or facilities (power plants, steam power plants, chemical plants, electronic works, electronic workshops, and other production units of which production capacity and resources efficiency are primary concerns) or renovation projects of existing facilities, to provide an evaluation mechanism for all sorts of correction curves that affect production capacity and efficiency for handling facility (system) degradation and operation condition at acceptance test being different from design point.

An objective of the present invention is to provide establishment of an evaluation and acceptance mechanism for an idea, a mechanism, a procedure and acceptance test for evaluation of such correction curves and is primarily set up for two categories; degradation of the facility (system) itself, and deviation of design point for ambient condition or system (equipment) interface condition, in order to provide a business unit with a proper evaluation and supplier selection mechanism, preventing the situation that good equipment (system) suppliers fail the tender, while the supplier with worse overall performance, after applying correction curves in terms of production capacity or efficiency, is awarded the contract. And eventually, to prevent the production facility or the private business suffering loss of performance.

### BRIEF DESCRIPTION OF THE DRAWINGS

FIG. 1 is a plot of efficiency-vs-operation hour degradation correction curve according to the present invention.

FIG. 2 is a plot of production capacity-vs-operation hour degradation correction curve according to the present invention.

FIG. 3 is a plot of production capacity-vs-ambient temperature correction curve according to the present invention.

FIG. 4 is a plot of efficiency-vs-relative humidity correction curve according to the present invention.

### DETAILED DESCRIPTION OF THE PREFERRED EMBODIMENT

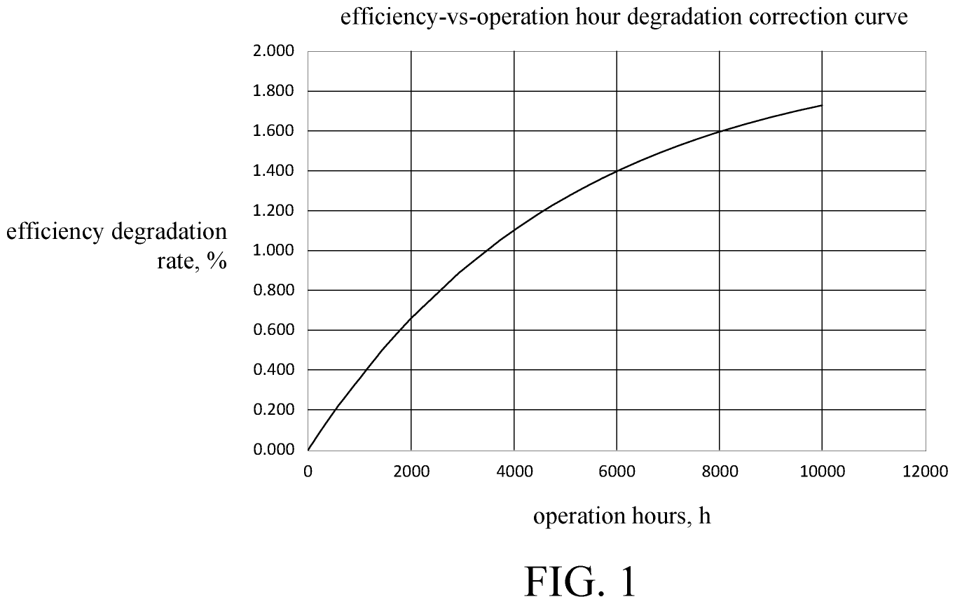

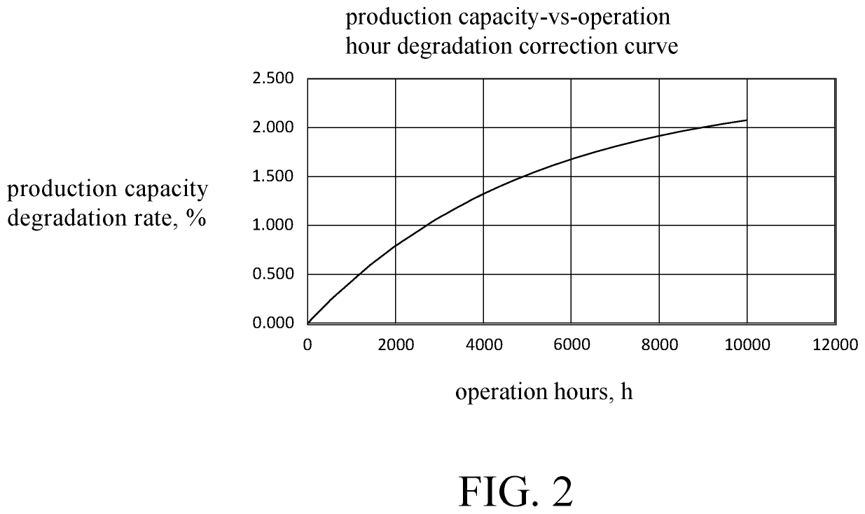

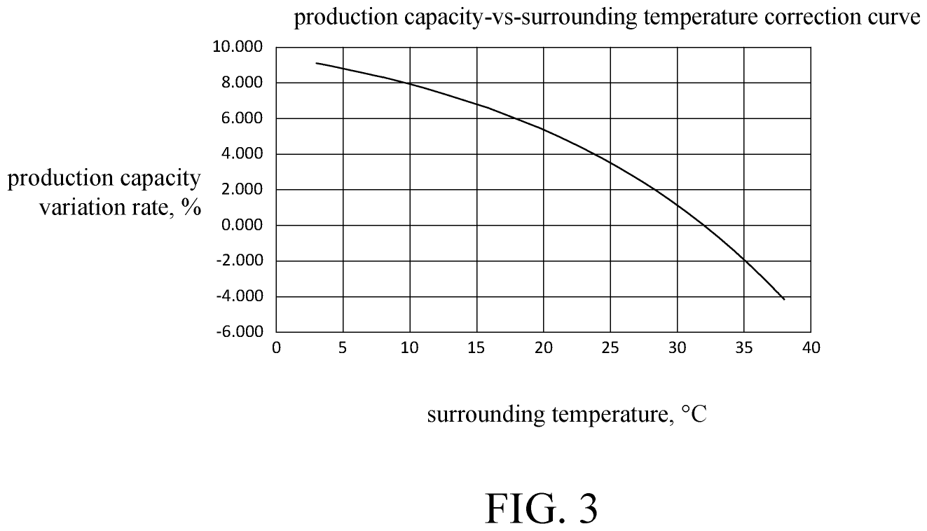

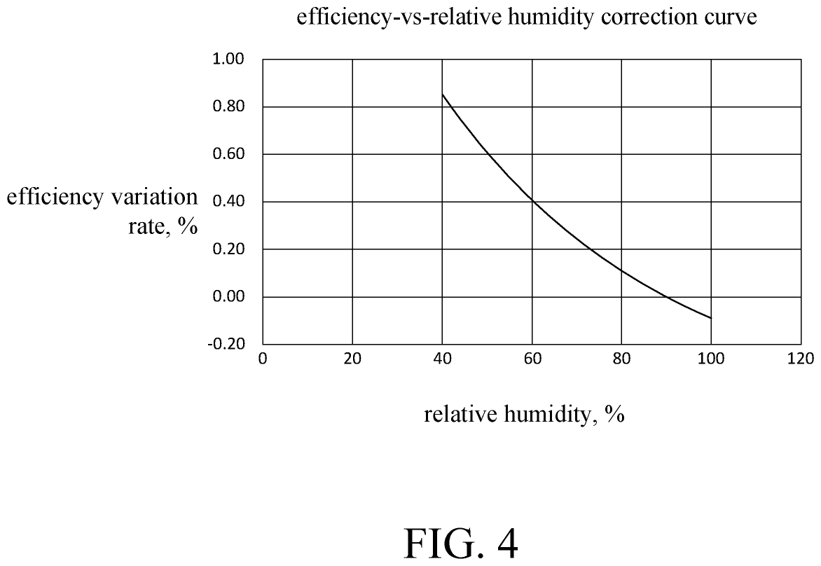

Referring to FIGS. 1-4, a proposal evaluation mechanism of equipment/system procurement for production plant or facility according to the present invention includes:

a supplier unit, which is provided to enable a plurality of suppliers to register and submit a first curve function and a second curve function, the first curve function including E_{f}(1st−X)=A(1−e^{-X/B}) and P_{f}(2nd−X)=C(1−e^{-X/D}), wherein

E_{f}: efficient-vs-operation hour degradation correction function, %;

1st−X: accumulated operation hours, h;

A and B: constants, which are entered by each of the suppliers;

P_{f}: production capacity-vs-operation hour degradation correction function, %;

2nd−X: accumulated operation hours, h;

C and D: constants, which are entered by each of the suppliers;

the second curve function including E_{f}(3rd−X)=E(e^{-X/F}−1)+G and P_{f}(4th−X)=K(e^{-X/L}−1)+M, wherein

E_{f}: efficiency-vs-design condition deviation correction curve function, %;

3rd−X: ambient (interface) condition variables, including temperature, pressure, humidity, and fuel heating value;

E, F, and G: constants, which are entered by each of the suppliers; P_{f}: production capacity-design condition deviation correction curve function %; 4th-X: ambient (interface) condition variables, including temperature, pressure, humidity, and fuel heating value;

K, L, and M: constants, which are entered by each of the suppliers, wherein the tender suppliers provide, in the project proposal or the technical document, the first curve function and the second curve function.

The tender suppliers only fills in the related constants. If the curve function formats provided by each of the suppliers provides are different from each other and is considered improper to use a unified format, it is also possible to allow each of the tender suppliers to provide the function format of the curves according to the technical characteristics related thereto;

a first setting unit shall be provided to receive the first curve function of each of the suppliers. The first setting unit shall be provided for setting of a first evaluation efficiency curve function and a first evaluation production capacity curve function. The first evaluation efficiency curve function is indicated as follows:

E_{cf}[100−(A_{Ef}+Cₑ·H_{E})/H_{E}]/100, wherein

Cₑ=E_{f}(H_{O}): facility (system) efficiency degradation rate for accumulated H_{O} hours of operation, %;

E_{cf} efficiency degradation correction factor, %;

A_{Ef}: area between the efficiency degradation curve and X axis from facility (system) starting operation to H_{O} hours, %×h, and including weighted equivalent area calculated according to time value of each time period;

H_{O}: maximum allowable accumulated operation hours for degradation tests carried out by the owner during the contract period, h;

H_{E}: total operation hours during evaluation calculation years (such as evaluation period being 15 years), h;

the first evaluation production capacity curve function being P_{cf}=[100−(A_{Pf}+C_{P}·H_{E})/H_{E}]/100, wherein

C_{P}=P_{f}(H_{O}): facility (system) production capacity degradation rate for accumulated H_{O} hours of operation, %;

P_{cf}: production capacity degradation correction factor, %;

A_{Pf}: area between the production capacity degradation curve and X axis from facility (system) starting operation to H_{O} hours, %·h;

H_{O}: maximum allowable accumulated operation hours for degradation tests carried out by the owner during the contract period, h;

H_{E}: total operation hours during the evaluation calculation years, h;

a first calculation unit shall be provided to receive the first evaluation efficiency curve function and the first evaluation production capacity curve function. The first calculation unit includes a first efficiency calculation function and a first production capacity calculation function. The first efficiency calculation function is indicated as E_{V}=E_{G}·E_{cf}, wherein

E_{V}: degradation-curve-involved evaluation efficiency;

E_{G}: degradation-curve-not-involved evaluation efficiency;

the first production capacity calculation function being P_{V}=P_{G}·P_{cf}, wherein

P_{V}: degradation-curve-involved evaluation production capacity;

P_{G}: degradation-curve-not-involved evaluation production capacity;

wherein the first efficiency calculation function and the first production capacity calculation function of each of the suppliers are calculated and then recorded for evaluation comparison. The evaluation will be carried out according to efficiency evaluation value stipulated in the tender invitation specification provided by the business unit or a consultant unit thereof by comparing the differences of the first efficiency calculation function and the first production capacity calculation function among the different tender suppliers, thereby, selecting the final winner for contract award;

wherein the first calculation unit supplies a first efficiency plot and a first production capacity plot as outputs of the first efficiency calculation function and the first production capacity calculation function respectively;

wherein in acceptance tests for the actual production capacity and efficiency, the business unit or a consultant unit thereof makes calculation of a guarantee vale from the correction curve according to the actual test time point and makes comparison with the production capacity and efficiency of the actual tests to then calculate and determine if the difference or deviation meet the guarantee value set forth in the contract, and if not, then the supplier is required to fulfill the contract according to the penalty articles stipulated in the specification.

A second setting unit shall be provided to receive the second curve function of each of the suppliers. The second setting unit shall be provided for setting of a second evaluation efficiency curve function and a second evaluation production capacity curve function. The second evaluation efficiency curve function is indicated as E_{cf}=[100−A_{Ef}/(X₁−X₀)]/100, wherein

E_{cf}: deviation-of-design-point efficiency correction factor, %;

A_{Ef}: area between the efficiency deviation curve and X axis for facility (system) located in interval of operation parameter between X₀ and X₁; in % X unit, wherein calculation of the area is made such that an area above 0 axis is counted as a positive value and that below 0 axis is a negative value, and the 0 axis is defined as the operation efficiency difference being 0 under the design condition. If the operation condition is not uniformly distributed, a weighted area shall be calculated from a curve of distribution thereof;

X₀: lower limit of operation parameter evaluation range;

X₁: upper limit of operation parameter evaluation range;

the second evaluation production capacity curve function being P_{cf}=[100−A_{Pf}/(X₁−X₀)]/100, wherein

P_{cf}: deviation-of-design-point production capacity correction factor, %;

A_{Pf}: area between the production capacity deviation curve and X axis for facility (system) located in interval of operation parameter between X₀ and X₁; in %×X unit, wherein calculation of the area is made such that an area above 0 axis is counted as a positive value and that below 0 axis is a negative value, and the 0 axis is defined as the operation efficiency difference being 0 under the design condition. If the operation condition is not uniformly distributed, a weighted area shall be calculated from a curve of distribution thereof;

X₀: lower limit of operation parameter evaluation range;

X₁: upper limit of operation parameter evaluation range;

a second calculation unit shall be provided to receive the second evaluation efficiency curve function and the second evaluation production capacity curve function. The second calculation unit includes a second efficiency calculation function and a second production capacity calculation function. The first efficiency calculation function is indicated as E_{V}=E_{G}·E_{cf}, wherein

E_{V}: deviation-involved design point correction curve evaluation efficiency;

E_{G}: deviation-not-involved design point correction curve evaluation efficiency;

the second production capacity calculation function being P_{V}=P_{G}·P_{cf}, wherein

P_{V}: deviation-involved design point correction curve evaluation production capacity;

P_{G}: deviation-not-involved design point correction curve evaluation production capacity;

wherein the second efficiency calculation function and the second production capacity calculation function of each of the suppliers are calculated and then recorded for evaluation comparison.

Wherein the second calculation unit supplies a second efficiency plot and a second production capacity plot as outputs of the second efficiency calculation function and the second production capacity calculation function respectively;

wherein in evaluation, differences of E_{V} among different tender suppliers are compared according to efficiency evaluation value stipulated in the tender invitation specification provided by the business unit or a consultant unit thereby, selecting the final winner for contract award;

Based on the result of operation and calculation described above, an idea, a mechanism, a procedure, and acceptance test mechanism of evaluation based on facility (system) degradation correction curves and an idea, a mechanism, a procedure, and acceptance test mechanism of evaluation based on ambient (interface) design condition deviation correction curves are formed:

(1) For production facility (system) that may generate significant degradation due to accumulation of operation hours, cares shall be taken for operation hours issue. During completion of plant construction and acceptance test, delay is commonly encountered for acceptance testing due to production demand or availability of the facility (system) itself. Therefore, the accumulated operation hours may be much higher than the set number of operation hours for acceptance. To prevent the business unit from suffering loss of performance resulting from application of improper degradation correction curves provided by the contractors, it is necessary to request, in the tender specification or project document, the tender suppliers to provide such curves and carry out necessary evaluation to identify which bidder is superior.

(2) For facility (system) that generate significant deviation in efficiency or production capacity resulting from the operation condition being different from the design condition, cares shall be taken for design deviation issue. During acceptance test, it often happens that differences of the ambient (interface) condition at the site of the facility result in the production capacity or efficiency being worse than the design condition. To prevent the business unit from suffering loss of performance resulting from application of improper design-condition-deviation correction curves provided by the contractors, it is necessary to request in the tender specification or project document, the tender suppliers to provide such curves and carry out necessary evaluation to identify which bidder is superior Rules of evaluation, acceptance, and penalty, including provision of curve functions, evaluation calculation procedures, process for acceptance, and penalty rules shall be set forth in the tender specification by the business unit or consultant unit.

I claim:

1. A proposal evaluation mechanism of equipment/system procurement for production plant or facility, comprising:
a supplier unit, which is provided to enable a plurality of suppliers to register and submit a first curve function and a second curve function, the first curve function including E_{f}(1st−X)=A(1−e^{-X/B}) and P_{f}(2nd−X)=C(1−e^{-X/D}), wherein
E_{f}: efficient-vs-operation hours degradation correction function, %;
1st−X: accumulated operation hours, h;
A and B: constants, which are entered by each of the suppliers;
P_{f}: production capacity-vs-operation hours degradation correction function, %;
2nd−X: accumulated operation hours, h;
C and D: constants, which are entered by each of the suppliers, wherein for situations where formats of the curve functions provided by the suppliers are different and are not suitable for submission with a unified format, the function formats of the tender suppliers are allowed to supply in accordance with technical characteristics thereof;
the second curve function including E_{f}(3rd−X)=E(e^{-X/F}−1)+G and P_{f}(4th−X)=K(e^{-X/L}−1)+M, wherein
E_{f}: efficiency-vs-design condition deviation correction curve function, %;
3rd−X: ambient (interface) condition variables, including temperature, pressure, humidity, and fuel heat value;
E, F, and G: constants, which are entered by each of the suppliers;
P_{f}: production capacity-design condition deviation correction curve function %;
4th−X: ambient (interface) condition variables, including temperature, pressure, humidity, and fuel heat value;
K, L, and M: constants, which are entered by each of the suppliers, wherein for situations where formats of the curve functions provided by the suppliers are different and are not suitable for submission with a unified format, the function formats of the tender suppliers are allowed to supply in accordance with technical characteristics thereof;
a first setting unit, which is provided to receive the first curve function of each of the suppliers, the first setting unit being provided for setting of a first evaluation efficiency curve function and a first evaluation production capacity curve function, the first evaluation efficiency curve function being E_{cf}[100−(A_{Ef}+Cₑ·H_{E})/H_{E}]/100, wherein
Cₑ=E_{f}(H_{O}): facility (system) efficiency degradation rate for accumulated H_{O} hours of operation, %;
E_{cf}: efficiency degradation correction factor, %;
A_{Ef}: area between the efficiency degradation curve and X axis from facility (system) starting operation to H_{O} hours, %×h, and including weighted equivalent area calculated according to time value of each time period;
H_{O}: maximum allowable accumulated operation hours for degradation tests carried out by the owner during the contract period, h;
H_{E}: total operation hours during evaluation calculation years, h;
the first evaluation production capacity curve function being P_{cf}=[100−(A_{Pf}+C_{P}·H_{E})/H_{E}]/100, wherein
C_{P}=P_{f}(H_{O}): facility (system) production capacity degradation rate for accumulated H_{O} hours of operation, %;
P_{cf}: production capacity degradation correction factor, %;
A_{Pf}: area between the production capacity degradation curve and X axis from facility (system) starting operation to H_{O} hours, %·h;
H_{O}: maximum allowable accumulated operation hours for degradation tests carried out by the owner during the contract period, h;
H_{E}: total operation hours during the evaluation calculation years, h;
a first calculation unit, which is provided to receive the first evaluation efficiency curve function and the first evaluation production capacity curve function, the first calculation unit including a first efficiency calculation function and a first production capacity calculation function, the first efficiency calculation function being E_{V}=E_{G}·E_{cf}, wherein
E_{V}: degradation-curve-involved evaluation efficiency;
E_{G}: degradation-curve-not-involved evaluation efficiency;
the first production capacity calculation function being P_{V}=P_{G}·P_{c}f, wherein
P_{V}: degradation-curve-involved evaluation production capacity;
P_{G}: degradation-curve-not-involved evaluation production capacity;
wherein the first efficiency calculation function and the first production capacity calculation function of each of the suppliers are calculated and then recorded for evaluation comparison;
a second setting unit shall be provided to receive the second curve function of each of the suppliers; the second setting unit shall be provided for setting of a second evaluation efficiency curve function and a second evaluation production capacity curve function; the second evaluation efficiency curve function is indicated as follows:
E_{cf}=[100−A_{Ef}/(X₁−X₀)]/100, wherein
E_{cf}: deviation-of-design-point efficiency correction factor, %;
A_{Ef}: area between the efficiency deviation curve and X axis for facility (system) located in interval of operation parameter between X₀ and X₁, %×X, wherein calculation of the area is made such that an area above 0 axis is counted as a positive value and that below 0 axis is a negative value, and the 0 axis is defined as the operation efficiency difference being 0 under the design condition; if the operation condition is not uniformly distributed, a weighted area shall be applied for calculation from a curve of distribution thereof;
X₀: lower limit of operation parameter evaluation range;
X₁: upper limit of operation parameter evaluation range;
the second evaluation production capacity curve function being P_{cf}=[100−A_{Pf}/(X₁−X₀)]/100, wherein
P_{cf}: deviation-of-design-point production capacity correction factor, %;
A_{Pf}: area between the production capacity deviation curve and X axis for facility (system) located in interval of operation parameter between X₀ and X₁, %×X, wherein calculation of the area is made such that an area above 0 axis is counted as a positive value and that below 0 axis is a negative value, and the 0 axis is defined as the operation efficiency difference being 0 under the design condition; if the operation condition is not uniformly distributed, a weighted area shall be applied for calculation from a curve of distribution thereof;
X₀: lower limit of operation parameter evaluation range;
X₁: upper limit of operation parameter evaluation range;
a second calculation unit shall be provided to receive the second evaluation efficiency curve function and the second evaluation production capacity curve function; the second calculation unit includes a second efficiency calculation function and a second production capacity calculation function; the first efficiency calculation function is indicated as follows:
E_{V}=E_{G}·E_{cf}, wherein
E_{V}: deviation-involved design point correction curve evaluation efficiency;
E_{G}: deviation-not-involved design point correction curve evaluation efficiency;
the second production capacity calculation function is indicated as follows:
P_{V}=P_{G}·P_{cf}, wherein
P_{V}: deviation-involved design point correction curve evaluation production capacity;
P_{G}: deviation-not-involved design point correction curve evaluation production capacity;
wherein the second efficiency calculation function and the second production capacity calculation function of each of the suppliers are calculated and then recorded for evaluation comparison.

2. The proposal evaluation mechanism of equipment/system procurement for production plant or facility according to claim 1, wherein the first calculation unit supplies a first efficiency plot and a first production capacity plot as outputs of the first efficiency calculation function and the first production capacity calculation function respectively.

3. The proposal evaluation mechanism of equipment/system procurement for production plant or facility according to claim 1, wherein the second calculation unit supplies a second efficiency plot and a second production capacity plot as outputs of the second efficiency calculation function and the second production capacity calculation function respectively.
